(19) United States
(12) Patent Application Publication
(10) Pub. No.: US 2013/0283238 A1
(43) Pub. Date: Oct. 24, 2013

(54) TESTING SYSTEM FOR AN INTEGRATED SOFTWARE SYSTEM

(71) Applicant: DORON LEVI, Modiin (IL)

(72) Inventor: DORON LEVI, Modiin (IL)

(21) Appl. No.: 13/450,788

(22) Filed: Apr. 19, 2012

(51) Int. Cl. G06F 9/44

(52) U.S. Cl. 717/126; 717/124

(57) ABSTRACT

Systems and methods are provided for testing an integrated software system. A scenario is generated as a hierarchical data object in which configuration parameters for each of a plurality of methods associated with a mock object are related to an associated method signature. A mock object, implemented as a stateless proxy for the plurality of methods, is injected into the integrated software system. The mock object is invoked with provided input data and configuration parameters stored at the scenario.

### TECHNICAL FIELD

This invention relates to software testing, and more particularly, to a testing system for integration testing.

### BACKGROUND

Software testing plays a role in the development of computer software and is used to confirm whether or not the quality or performance of a software program conforms to some requirements raised before the development of the software. Software testing can include an inspection of software requirement analysis, design specification description, and coding before software is put into practice and is a key step for guaranteeing software quality. Essentially, it is a process of executing a program in order to find errors. Software testing may be divided into unit testing and integration testing, wherein unit testing is a testing of the minimum unit of software design, while integration testing is a testing of the whole software system. After respective modules having passed unit testing are assembled together according to design requirements, integration testing is performed to find various interface-related errors.

### BRIEF DESCRIPTION OF THE DRAWINGS

FIG. 1 illustrates a testing system for an integrated software system;

FIG. 2 illustrates one example of a holistic testing framework in an integrated software system;

FIG. 3 illustrates a recorder system for capturing desired behaviors for mock objects to generate testing scenarios;

FIG. 4 illustrates one method for testing an integrated software system;

FIG. 5 illustrates one example of a method for invoking a mock object;

FIG. 6 is a schematic block diagram illustrating an exemplary system of hardware components.

### DETAILED DESCRIPTION

A holistic mocking framework is provided for integrated software testing applications. The Arrange, Act and Assert (AAA) model facilitates setting up tests utilizing mocks, fakes, stubs, and similar simulations of existing systems by implementing the test in a logical order. In an arrange phase, the unit under test is set-up, including creation of a mock object, configuration of its behavior in this test case, and finally injection of the mock object into the unit under test (e.g., via parameter or constructor injection). In an act phase, the unit is exercised under test, and any resulting state is captured. In an assert phase, the behavior is verified through assertions. In complex, integrated testing applications, strict adherence to the AAA model is generally not practical. The holistic mocking framework provided herein allows for complex testing arrangements that are consistent with this model, allowing for tests that are easy to read, understand, and maintain.

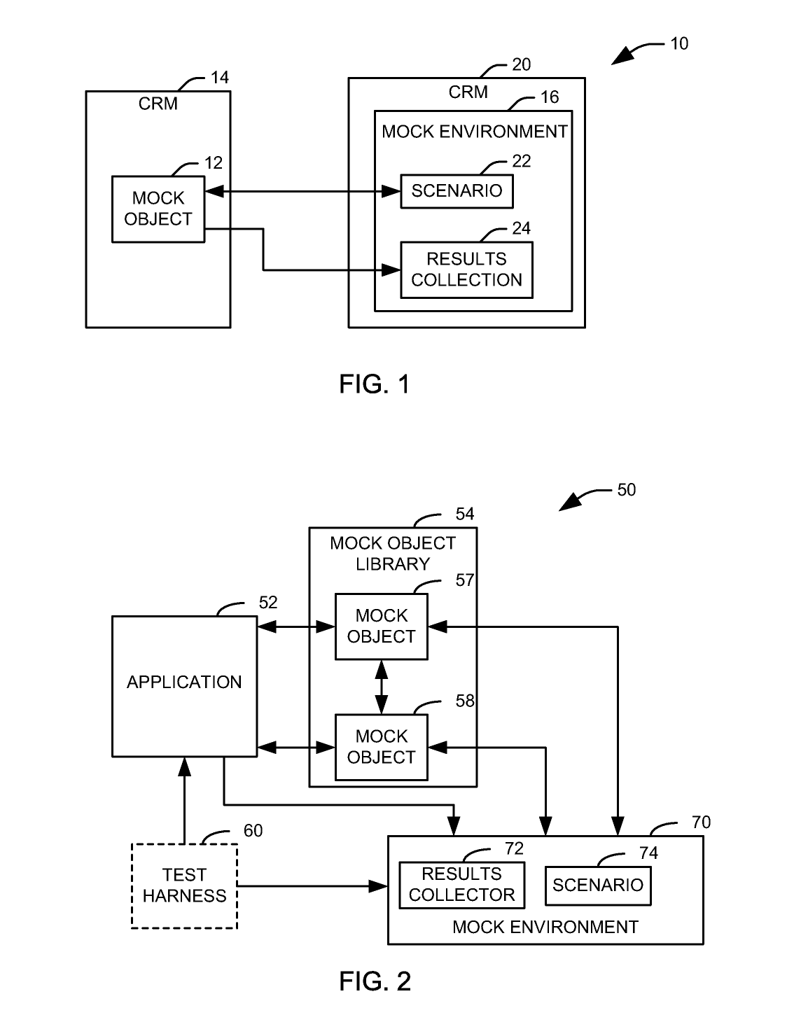

FIG. 1 illustrates a testing system 10 for an integrated software system. The system includes a mock object 12 implemented as machine executable instructions on a first non-transitory computer readable medium (CRM) 14. The mock object 12 is implemented as a stateless proxy associated with a corresponding real object in the integrated software system. A mock environment 16 manages a context of the mock object, wherein the context includes a virtual state of the mock object and collected input and output data for the mock object. In the illustrated implementation, the mock environment 16 is implemented as machine executable instructions on a second non-transitory computer readable medium 20, although it will be appreciated that the testing agent could also be implemented on the first non-transitory computer readable medium 14.

The mock environment 16 includes a scenario 22 to store configuration data for the mock object representing methods associated with the real object. The scenario 22 can include a programmed collection of steps for each unique method signature associated with the mocked real object to model its behavior in response to invocation of the mock object. For example, the programmed behaviors can include return values, output and reference parameter values, exception throwing, event raising, callback execution, and similar behaviors. During execution, the mock object 12 refers to the scenario 22 to determine how it should proceed when an associated method is invoked. In one implementation, the mock object 12 is one of a plurality of mock objects, and the scenario 22 comprises a hierarchical data structure storing configuration data for each of the plurality of mock objects.

The mock environment includes a results collection component 24 to collect input data provided to the mock object and outputs generated by the mock object. In one implementation, the results collection component 24 selectively collects the input data and outputs such that less than all of the input data and outputs are collected. By selectively collecting input and output data, an efficiency of the testing system 10 can be enhanced.

FIG. 2 illustrates one example of a holistic testing framework in an integrated software system 50. The system includes an application 52 under test from the integrated software system. The testing framework includes a mock object library 54 comprising a plurality of mock objects 57-58 representing system components that are either not completed or undesirable to include when performing integration testing. Each mock object 57-58 is created at a time of execution as a stateless proxy representing a real object associated with the integrated software system. A given mock object (e.g., 57) can include an input data collector for receiving and recording input data provided to the mock object from other system components (e.g., 52 and 58) as well as an output data collector for execution data provided in response to received input. In one implementation, each mock object 57 and 58 can include a number of preexecution and postexecution triggers to provide custom behaviors for the mock object that can be executed in response to an event. For example, the trigger can be executed in response to input data provided to the mock object, outputs generated by the mock object, or invocation of a method associated with the mock object.

In the illustrated system, configuration data for the behaviors of a mock object (e.g., 57) can be stored in a portable data model referred to as a scenario. The scenario is implemented as a hierarchical data structure storing configuration data representing the behaviors of the mock object or mock objects that it represents. For example, for each mock object, an associated plurality of methods can be represented as a collection of method steps, with associated configuration data. Each collection of method steps can be associated with the mock type and a unique method signature. The scenario can also store data collection rules specific to each method that govern the specific input and output data collected when each method is invoked.

The system 50 interacts with a test harness 60 that provides an interface for an associated user and generally manages a context of the testing environment. The test harness 60 can be a testing framework selected by a user. The test harness 60 can be operatively connected to a mock environment 70 representing a context of the testing framework. The mock environment 70 includes a result collector 72 that collects test data from the application 52 and the plurality of mock objects 57 and 58. The context represented by the mock environment 70 includes the collected results from the application 52 and the mock objects 57 and 58 as well as a scenario 74 that provides a behavior configuration for the mock objects 57 and 58. Since the mock objects 57 and 58 are stateless proxies, a new scenario can be provided at any time to completely alter the behavior of the mock objects, even when the testing environment is live.

During execution, when a mock object 57 and 58 is invoked, it requests instructions from the active scenario on how to proceed based on the parameters passed to the in the invocation and configuration stored at the scenario and acts accordingly. Input data and outputs from the mock object, including output parameters, returned values, and raised exceptions, can be collected and validated at the at the mock environment 70. It will be appreciated that the data can be collected selectively, with only data relevant to a given test collected. The mock objects 57 and 58 can also support preexecution and postexecution triggers, which are custom behaviors that can be programmed into the mock. These triggers can be conditions on a particular event associated with the input or output data or simply configured to execute every time the mock object is invoked. For example, a mock object may be instructed to sleep for a given amount milliseconds after it is invoked.

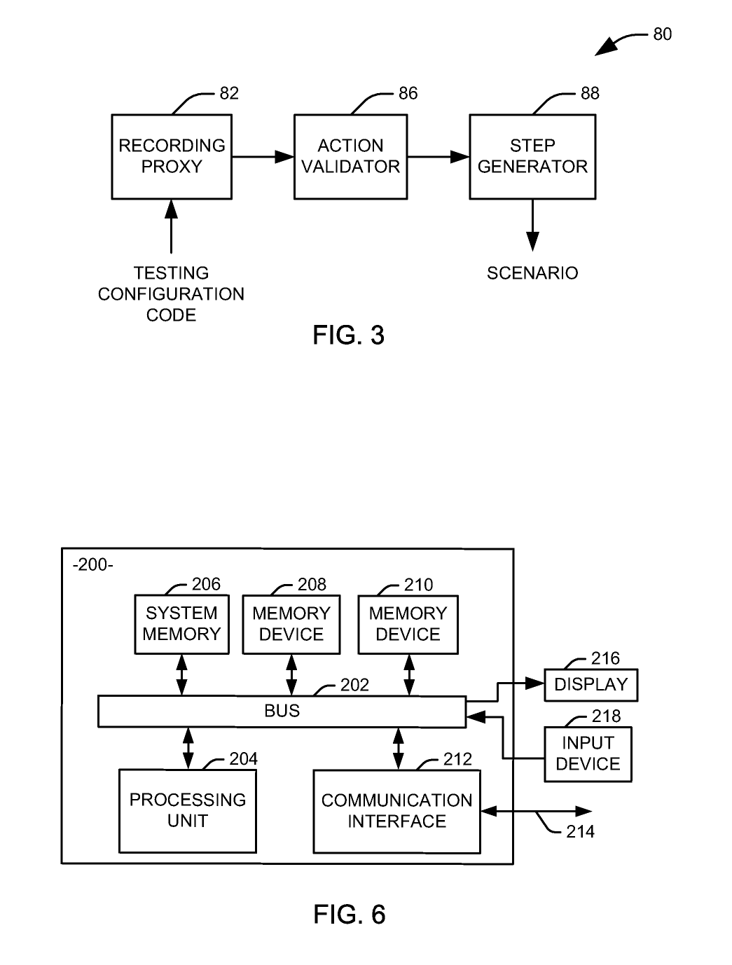

FIG. 3 illustrates a recorder system 80 for capturing desired behaviors for mock objects to generate testing scenarios. The recorder system 80 includes a recording proxy 82 that collects data characterizing the methods associated with the mocked real object represented by the mock object. In the illustrated implementation, the recorder system 80 utilizes a fluent application program interface to capture the desired behavior for the mocked object from a set of testing configuration code. The resulting commands are then subjected to validation checks at an action validator 86 to ensure that the determined commands are legal for a programmed interface. A step generator 88 creates the steps defining each method associated with the mocked object. For example, supported behaviors can include return values, input and output reference parameter values, exception throwing, event raising, executing callbacks. It can also establish rules for collecting data at run time for outcome analysis as well as triggers for the mock object to establish custom behavior. The steps representing one or more mocked objects can be collected into a hierarchical data structure as the scenario for a given test.

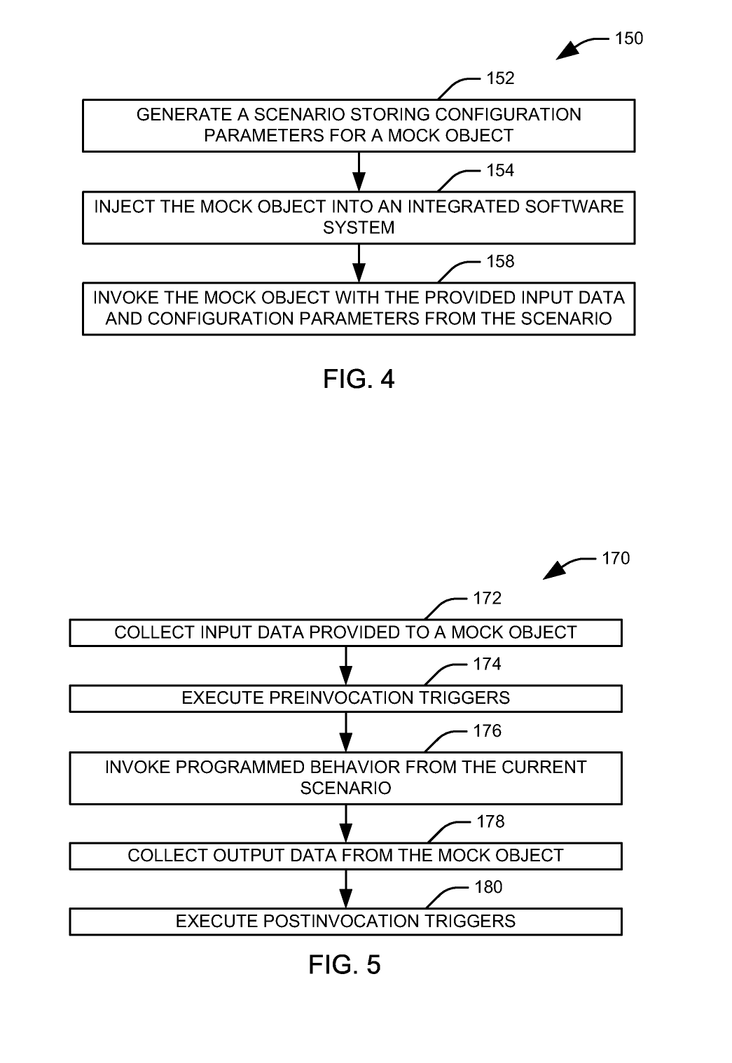

In view of the foregoing structural and functional features described above in FIGS. 1-3, example methodologies will be better appreciated with reference to FIGS. 4 and 5. While, for purposes of simplicity of explanation, the methodologies of FIGS. 4 and 5 are shown and described as executing serially, it is to be understood and appreciated that the present invention is not limited by the illustrated order, as some actions could in other examples occur in different orders and/or concurrently from that shown and described herein.

FIG. 4 illustrates one method 150 for testing an integrated software system. It will be appreciated that the method 150 can be implemented as machine readable instructions stored on one or more non-transitory computer readable media and executed by associated processor(s). At 152, a scenario is generated as a hierarchical data object in which configuration parameters for each of a plurality of methods associated with a mock object are related to associated method signatures. The testing scenario models the behavior of mock objects used in testing the integrated software system. Accordingly, a recording component can be used to capture the desired behavior of the mock object and store it in the scenario, which is a complex data structure called that relates the configuration uniquely to type and method signatures associated with the mock object. It will be appreciated that a given mock object can represent multiple scenarios. In one implementation, the scenario is generated using an appropriate object creation tool such as a design pattern or a fluent application program interface. The determined configuring code can be validated to ensure that the programming is correct with respect to the programmed interface. For example, it can be verified that input parameters, output parameters, and return values are specified correctly, and various errors that can caught at compile time are checked for. The scenario can also define what information will be collected for each method during runtime, including specific input and output parameters, return values, number of calls, and similar values.

At 154, a mock object, implemented as a stateless proxy for a plurality of associated methods, is injected into the integrated software system. This can be accomplished through dependency injection or by plugging a mock factory to a central location at which objects are created, such as an Inversion of Control (IoC) container configuration or a Windows Communication Foundation (WCF) instance provider. It will be appreciated that the stateless nature of mock objects simplifies injection of the mock object into the system in a manner consistent with the AAA model.

At 158, a method of the plurality of methods associated with the mock object is invoked with provided input data and configuration parameters stored at the scenario. In practice, integration testing can involve the execution of a use case on the tested system, and methods associated with the mock object can be invoked by other components in the system that interact with them. The mock object asks the scenario, via the current context, how to proceed based upon the configuration parameters and acts accordingly. As part of the invocation, execution parameters associated with the method can be updated at a result collection component. Any or all of the input data, output of the invoked method or methods, returned values, raised exceptions, and other such data can be collected prior to and during invocation of the method. At 160, the collected data is verified according to rules associated with the method. For example, the rules can include expected input parameter values, expected output parameter values, expected return values, expected numbers of calls, expected failures for various exceptions, and a successful termination of the method.

It will be appreciated that, since the mock objects are stateless, the behavior of a given mock object can be completely changed by replacing the scenario with a new scenario containing different configuration data. Similarly, by replacing the current context, that is, the scenario, the collected data, and all expected results, it is possible to completely reset the testing environment without any need to recreate or reconfigure any of the mock objects. This allows for multiple situations to be tested without needing to tear down a live testing environment.

FIG. 5 illustrates one example of a method 170 for invoking a mock object. At 172, input data provided to the mock object is collected and provided to a mock environment result collection component. The data collected can be fine-grained and tuned such that less than all of the input data is collected. For example, for each method associated with a given mock object, specific input parameters can be collected. By limiting the amount of input data collected and verified, the testing can be expedited. At 174, preinvocation triggers associated with the mock object can be executed, either automatically in response to the input data, or in response to an event associated with either the input data or the invoking of the mock object. The preinvocation triggers can be added to the mock objects to represent desired custom behaviors when the mock object is programmed.

At 176, programmed behavior for the mock object is invoked. The scenario stores programmed behavior for each of a plurality of methods associated with the mock object, and appropriate behavior can be selected and provided to the mock object according to the stored configuration data for a specific mock type and method signature. If the mock object utilizes events registration, then subscribers and publishers of a given event are recorded and mapped to allow both tracking and simulating of cross-component interactions.

At 178, output values are collected for verification, including any of output parameter values, returned values, and raised exceptions provided by the invoked method. Like the collection of the input data, the collection of the output data can be fine-grained and tuned such that less than all of the output data is collected, such that for each method associated with a given mock object, specific output parameters, return values, and exceptions can be collected. At 180, postinvocation triggers associated with the mock object can be executed, either automatically in response to invocation of the mock object, or in response to an event associated with the object output. Like the preinvocation triggers, the postinvocation triggers can be added to the mock objects to represent desired custom behaviors when the mock object is programmed.

FIG. 6 is a schematic block diagram illustrating an exemplary system 200 of hardware components capable of implementing examples of the systems and methods disclosed in FIGS. 1-5, such as the testing framework illustrated in FIGS. 1 and 2. The system 200 can include various systems and subsystems. The system 200 can be a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 interconnects the processing unit 204, the memory devices 206-210, the communication interface 212, the display 216, and the input device 218. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include a processing core.

The additional memory devices 206, 208 and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in different human.

Additionally or alternatively, the system 200 can access an external data source or query source through the communication interface 212, which can communicate with the system bus 202 and the communication link 214.

In operation, the system 200 can be used to implement one or more applications in an integrated software system or one or more parts of the testing framework for evaluating the integrated software system. Computer executable logic for implementing the testing framework resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A testing system for an integrated software system comprising:
a mock object implemented as machine executable instructions on a first non-transitory computer readable medium, the mock object implemented as a stateless proxy associated with a corresponding real object in the integrated software system; and
a scenario, implemented as machine executable instructions on one of the first non-transitory computer readable medium and a second non-transitory computer readable medium, to store configuration data for the mock object representing methods associated with the real object.

2. The testing system of claim 1, wherein the mock object is one of a plurality of mock objects and the scenario is part of a mock environment representing a context of the testing system, the scenario is common to the plurality of mock objects and comprises a hierarchical data structure storing configuration data for each of the plurality of mock objects.

3. The testing system of claim 2, the mock environment further comprising a results collection component to collect input data provided to each of the plurality of mock objects and outputs generated by the plurality of mock objects and verify the collected values against expected values.

4. The testing system of claim 3, the results collection component selectively collecting the input data and outputs generated by the plurality of mock objects such that less than all of the input data and outputs are collected.

5. A method, implemented as machine readable instructions executed by an associated processor, for testing an integrated software system, the method comprising:
generating a scenario as a hierarchical data object in which configuration parameters for each of a plurality of methods associated with a mock object are related to an associated method signature;
injecting the mock object, implemented as a stateless proxy for the plurality of methods, into the integrated software system; and
invoking the mock object with configuration parameters stored at the scenario and with provided input data.

6. The method of claim 5, further comprising collecting an output provided by the invoked mock object, the output comprising one of an output parameter value, a returned value, and a raised exception.

7. The method of claim 6, wherein the invoked mock object provides a plurality of outputs, each comprising one of an output parameter, a returned value, and a raised exception, and
wherein collecting an output comprises collecting less than all of the plurality of outputs.

8. The method of claim 6, further comprising verifying the collected output against an expected output.

9. The method of claim 5, wherein invoking the mock object comprises updating execution parameters at a result collection component.

10. The method of claim 5, wherein invoking the mock object involves an event having a registered subscriber, the method further comprising recording one of a subscriber and a publisher associated with the event.

11. The method of claim 5, further comprising:
generating a new scenario having a new set of configuration parameters associated with the mock object; and
invoking the mock object with the new set of configuration parameters.

12. The method of claim 5, further comprising:
selectively collecting an input from the provided input data, such that less than all of the input data is collected; and
storing the collected input data in a mock environment.

13. The method of claim 12, further comprising verifying the collected input against an expected input parameter value.

14. The method of claim 5, further comprising executing a trigger associated with the mock object in response to an event associated with one of the input data and the invoking of the mock object.

15. A method, implemented as machine readable instructions executed by an associated processor, for testing an integrated software system, the method comprising:
generating a scenario as a hierarchical data object in which configuration parameters for each of a plurality of methods associated with a mock object are related to an associated method signature;
generating a mock object as a stateless proxy representing the plurality of methods;
providing input data to the mock object;
collecting an input from the input data;
invoking the mock object with the provided input data and configuration parameters stored at the scenario
collecting an output comprising one of an output parameter value, a returned value, and a raised exception provided by the invoked mock object; and
verifying each of the collected input and the collected output against respective expected values.
